(19) United States
(12) Patent Application Publication
(10) Pub. No.: US 2025/0065253 A1
(43) Pub. Date: Feb. 27, 2025

(54) HIGH TRANSMISSION AIR FILTRATION MEDIA AND TRANSPARENT FACE MASK

(71) Applicant: 3M INNOVATIVE PROPERTIES COMPANY, St. Paul, MN (US)

(72) Inventors: GuangMing Gong, Shanghai (CN); Liyun Ren, Woodbury, MN (US)

(21) Appl. No.: 18/726,282

(22) PCT Filed: Jan. 7, 2022
(86) PCT No.: PCT/CN2022/070631

§ 371 Date: Jul. 2, 2024

(51) Int. Cl. B01D 39/16; A62B 23/02; D04H 1/4309; D04H 1/4318; D04H 1/435; D04H 1/4382; D04H 1/728

(52) U.S. Cl. CPC B01D 39/1623; A62B 23/025; D04H 1/4309; D04H 1/4318; D04H 1/435; D04H 1/43838; D04H 1/728; B01D 2239/025; B01D 2239/0618; B01D 2239/0627; B01D 2239/0631; B01D 2239/0654; B01D 2239/1208; B01D 2239/1291; D10B 2331/041; D10B 2401/10; D10B 2501/04; D10B 2505/04

(57) ABSTRACT

The present invention is an electrospun web including a carrier substrate and an electrostatically charged nanofiber. The electrospun web has a pressure drop of about 5 mmH2O or less, a percent penetration of about 50% or less, and a clarity of about 80% or more.

### FIELD OF THE INVENTION

The present invention is related generally to the field of face masks. In particular, the present invention is a face mask having a high transmission air filtration media and is transparent.

### BACKGROUND

It is well-known in the field of speech communication that about 65% of personal communication messages comes from non-verbal cues (including facial expressions) while about 35 percent of the message stems from the actual verbal content of the speech. There is also consensus that when interacting with small children who may not understand all that is being said, the ability to see a person's face clearly is more reassuring and aids in comprehension and imitative learning. Research from the speech-language pathology field also shows that all people (normal-hearing as well as hearing-challenged) do a certain amount of speech-reading (e.g., lip reading) when conversing.

During a pandemic or other environmental threat, face masks and respirators can be an essential personal hygiene and safety protection element. However, traditional fabric masks and surgical masks can make human interaction and speech difficult. As a result, new air filter materials and face mask products with high transparency have been developed in recent years. For example, a surgical facemask with a clear window has been designed for hearing challenged people for reading lips. Another current product includes an enclosed facemask with a transparent shield.

### SUMMARY

In one embodiment, the present invention is an electrospun web including a carrier substrate and electrostatically charged nanofibers. The electrospun web has a pressure drop of about 5 mmH2O or less, a percent penetration of about 50% or less, and a clarity of about 80% or more.

In another embodiment, the present invention is a filtration media including a carrier layer and an electrospun nanofiber layer. The filtration media has a pressure drop of about 5 mmH2O or less, a percent penetration of about 50% or less, and a clarity of about 80% or more.

In yet another embodiment, the present invention is mask including an electrostatically charged spunbond nonwoven. The mask has a pressure drop of about 5 mmH2O or less, a filtration efficiency of about 40% or greater, and a clarity of about 80% or more.

### BRIEF DESCRIPTION OF THE DRAWINGS

FIG. 1 is a schematic diagram of an exemplary apparatus which may be used to form a spunbonded nonwoven web as disclosed herein.

FIG. 2 is a side view of an exemplary attenuator which may be used in the process of FIG. 1.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom”, “upper”, lower”, “under”, “over”, “front”, “back”, “outward”, “inward”, “up” and “down”, and “first” and “second” may be used in this disclosure, it should be understood that those terms are used in their relative sense only unless otherwise noted.

### DETAILED DESCRIPTION

The present invention is an electrospun web with high filtration efficiency, high optical transparency, and low resistance to air flow. The electrospun web includes a carrier substrate and electrostatically charged nanofibers. The electrostatic charging enhances the filtration performance of the nanofibers while maintaining low pressure drop and high transparency of the electrospun web. In one embodiment, the electrospun web is used as a filtration media in, for example, a mask. The filtration media can be used in various industries, such as the consumer mask business, consumer healthcare business, and/or medical care business. Because the resulting mask is transparent, communication and understanding between both the wearer and non-wearer is improved.

The electrospun web of the present invention is based on electrospinning technology in combination with electrostatic charging technology. The electrospun web includes a carrier substrate and electrostatically charged nanofibers. In one embodiment, the electrospun web has a pressure drop of about 5 mmH2O or less, a percent penetration of about 50% or less, and a clarity of about 80% or more. As used herein, the term “web” denotes a mass of nonwoven or woven fibers that are bonded to each other sufficiently that the mass of fibers has sufficient mechanical integrity to be handled as a self-supporting layer; e.g., that can be handled with conventional roll-to-roll web-handling equipment.

The carrier substrate functions to mount a thin layered web of electrostatically charged nanofibers. The carrier substrate material can hold charges during the electrospinning process, resulting in improved filtration efficiency through the high surface area of the nanofibers and microfibers with the assistance of electret charging. In one embodiment, the carrier substrate is a low basis weight nonwoven material. The low basis weight material can provide increased light transmission while providing sufficient mechanical support. Various materials can be used to form the carrier substrate, including, but not limited to: a nonwoven, a woven, a mesh, or a perforated film. In one embodiment, the carrier substrate is a spunbond nonwoven. Examples of suitable nonwoven materials for the carrier substrate include, but are not limited to a spunbond polypropylene or polylactic acid fabrics with a low basis weight. In one embodiment, the carrier substrate has a basis weight of about 30 gsm or less and particularly about 15 gsm or less.

The electrostatically charged nanofibers function to increase the filtration performance of the electrospun web. Generally, filtration efficiency increases with decreasing fiber size due to increased surface area of the nanofibers as the increased surface area enhances the filtration efficiency of the material. The electrostatically charged nanofibers have a low basis weight in order to facilitate high transparency. For electrospun materials, the smaller the fiber size, the higher the clarity because the nanofiber size is approaching the wavelength of visible light. In one embodiment, the electrostatically charged nanofibers have a basis weight of about 0.7 gsm or less and particularly about 0.5 gsm or less. In one embodiment, the nanofibers are made from fluorinated polymers. Examples of suitable fluorinated polymers include, but are not limited, to: polyvinylidene fluoride (PVDF), terpolymer of tetrafluoroethylene, hexafluoropropylene and vinylidene fluoride (THV), thermoplastic polyurethane (TPU), polyvinyl alcohol (PVA), polyamide 6 (PA6), and combinations thereof.

The electrospun web of the present invention is transparent and may have a translucent look. In one embodiment, the electrospun web has a frost-glass-look. When used as a filter media for a mask, this clarity allows the facial expressions of a wearer of the facemask to be viewed by others. In one embodiment, the electrospun web has a clarity of at least about 80%, particularly at least about 85%, and more particularly at least about 90%. Clarity is measured using ASTM D1003, conducted on a Qualtech Products Industry Haze Meter machine.

The joint filtration performances of the charged spunbond carrier substrate and the nanofibers provide a protective, transparent mask. To be used as a filtration material, the percent penetration should be as low as possible, indicating that the material has high filtration efficiency. Generally, the percent penetration measures how many particles can pass through the material. In one embodiment, the electrospun web of the present invention has a percent penetration of about 40% or less, particularly about 30% or less, and more particularly about 20% or less. In one embodiment, this percent penetration is substantially equivalent to a filtration efficiency of about 40% or greater, particularly about 50% or greater, and more particularly about 60% or greater. In one embodiment, the percent penetration or filtration efficiency can be measured using ASTM F3502 on a TSI 8130 air filtration tester (TSI Inc., Shoreview, MN), with an air flow rate of 85 liters per minute, 0.3 μm NaCl challenges with concentration of about 28 mg/m³.

The electrospun web has high breathability, allowing it to be used in a mask. The breathability, or breath resistivity, of the electrospun web can be measured by the pressure drop through the material. For high breathability, the pressure drop of the electrospun web should be as low as possible. In one embodiment, the electrospun web has a pressure drop of about 5 mmH2O or less with NaCl challenge media at 85 liters per minute, particularly 4 mmH2O or less, and more particularly about 3 mmH2O or less. The pressure drop can be measured, for example, using a TSI 8130 machine. The pressure drop can be tuned using various methods. For example, the carrier substrate may be perforated. In one embodiment, the carrier substrate has a porosity of about 50% or greater, particularly about 60% or greater, and more particularly about 80% or greater.

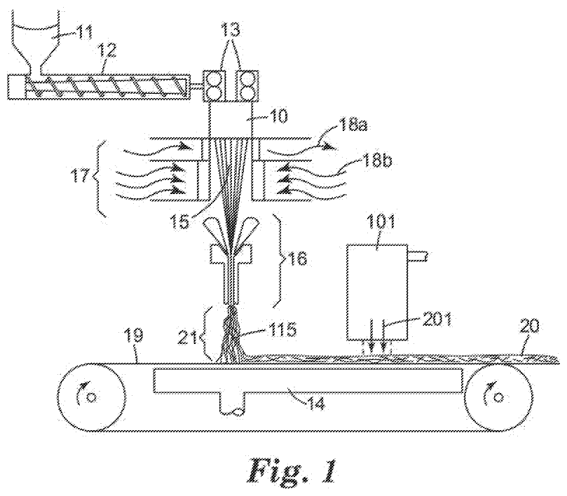

FIG. 1 shows an exemplary apparatus that may be used to form the electrospun webs of the present invention. As used herein, the term “mat” denotes a mass of fibers that are not bonded to each other sufficiently to form a self-supporting web (e.g. a mass of collected meltspun fibers that are not yet bonded to each other). By “spunbonded” is meant a web comprising a set of meltspun fibers that are collected as a fibrous web and optionally subjected to one or more bonding operations. In an exemplary method of using such an apparatus, fiber-forming material (often, in pellet or particulate form) is introduced into hopper 11 (along with a suitable amount of charging additive), whereupon the fiber-forming material (and charging additive, if added as a solid) are melted in an extruder 12, and pumped into extrusion bead 10 via pump 13.

Extrusion head 10 may be a conventional spinnerette or spin pack, generally including multiple orifices arranged in a regular pattern, e.g., straightline rows. Molten filaments 15 of fiber-forming liquid are extruded from the extrusion head and pass through air-filled space 17 to attenuator 16. The distance the extruded filaments 15 travel through air space 17 before reaching the attenuator 16 can vary, as can the conditions to which they are exposed. One or more streams of air 18 (e.g., quenching air) may be directed toward extruded filaments 15 to reduce the temperature of, and to at least partially solidify, the extruded filaments 15 to become fibers 115. (Although the term “air” is used for convenience herein, it is understood that this term encompasses other gases and/or gas mixtures that may be used in the quenching and drawing processes disclosed herein). If desired, multiple streams of air may be used; e.g., a first air stream 18a blown transversely to the filament stream, which may serve primarily to remove undesired gaseous materials or fumes released during extrusion, and a second quenching air stream(s) 18b that may serve primarily to achieve temperature reduction.

Fibers 115 may then be passed through an attenuator to draw the fibers, as illustrated in FIG. 1. Attenuator 16 is configured to impinge rapidly-moving streams of air onto the fibers, which streams of air are moving at least generally in the same direction as the fibers during at least a portion of the fibers' trip through the attenuator. The moving air thus exerts a shear force on the fibers, which shear force serves to draw the fibers (the moving air in the attenuator may also serve to cool and/or quench fibers 115, beyond any cooling and/or quenching of that may have already occurred in passing through the distance between extrusion head 10 and attenuator 16).

It will thus be appreciated that an attenuator as disclosed herein can serve as an alternative to long-used methods of drawing fibers by e.g. exerting force on the fibers by winding them (e.g. onto a bobbin or spool) at a speed faster than that at which the fibers are initially extruded. Such drawing may serve to achieve at least some orientation of at least a portion of each fiber. Such drawing may also be manifested in a reduction in the final diameter of the fiber from what the diameter would be in the absence of drawing. However, it has been discovered that drawing of polylactic acid fibers that comprise charging additive, can also have additional and unexpected benefits in preserving the fiber charge over high temperature aging, as discussed later herein.

The degree of drawing of fibers 115 may be characterized by the apparent fiber speed, which is calculated by the following equation:

$${V}_{appare , , t} ( m / min ) = 4 M / {p}_{rt} {d}_{f}^{2} \times 1000000$$

where:
M is the polymer flow rate in grams/per orifice per minute,
p is the polymer density, in grams per cubic centimeter, and
df is the measured average fiber diameter in micrometers.

One of skill in the art will appreciate that the apparent fiber speed takes into account the actual diameters of the fibers as made (i.e., the measured average diameter as obtained e.g. by optical microscopy) and the flow rate of molten filaments through the meltspinning orifices to provide a parameter that is indicative of the degree of drawing which occurred in transforming the extruded molten filaments into drawn fibers. In various embodiments, the apparent fiber speed may be at least about 1000, 2000, 3000, or 4000 meters per minute. In further embodiments, the apparent fiber speed may be at most about 14000, 12000, 10000, 8000, or 6000 meters per minute.

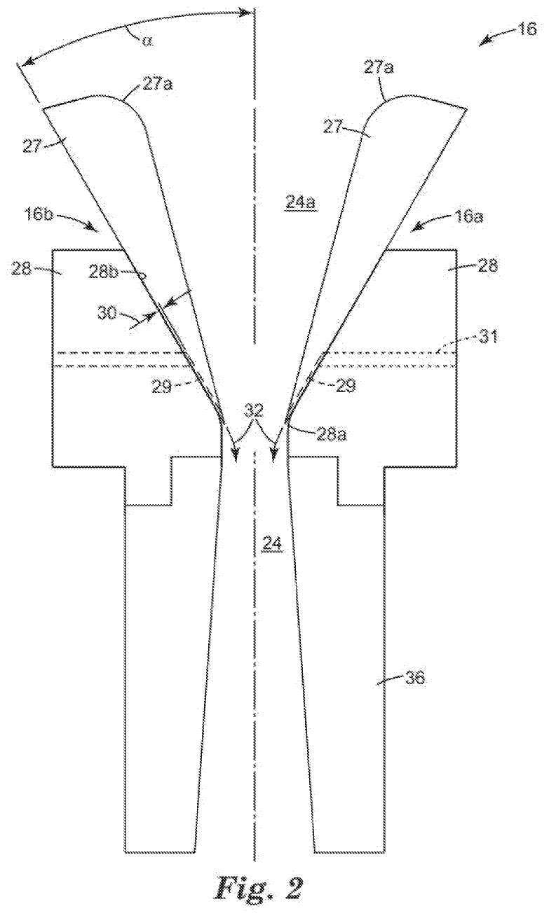

FIG. 2 is an enlarged side view of an exemplary attenuator 16. Exemplary attenuator 16 in some cases may comprise two halves or sides 16a and 16b separated so as to define between them an attenuation chamber 24, as in the design of FIG. 2. Although existing as two halves or sides (in this particular instance), attenuator 16 functions as one unitary device and will be first discussed in its combined form. Exemplary attenuator 16 includes slanted entry walls 27, which define an entrance space or throat 24a of the attenuation chamber 24. The entry walls 27 preferably are curved at the entry edge or surface 27a to smooth the entry of air streams carrying the fibers 115. The walls 27 are attached to a main body portion 28, and may be provided with a recessed area 29 to establish an air gap 30 between the body portion 28 and wall 27. Air may be introduced into the gaps 30 through conduits 31. The attenuator body 28 may be curved at 28a to smooth the passage of air from the air knife 32 into chamber 24. The angle (a) of the surface 28b of the attenuator body can be selected to determine the desired angle at which the air knife impacts a stream of fibers passing through the attenuator.

Attenuation chamber 24 may have a uniform gap width; or, as illustrated in FIG. 2, the gap width may vary along the length of the attenuator chamber. The walls defining at least a portion of the longitudinal length of the attenuation chamber 24 may take the form of plates 36 that are separate from, and attached to, the main body portion 28. In some embodiments, certain portions of attenuator 16 (e.g., sides 16a and 16b) may be able to move toward one another and/or away from one another, e.g. in response to a perturbation of the system. Such ability may be advantageous in some circumstances. Further details of exemplary attenuators and possible variations thereof are found in U.S. Pat. Nos. 6,607,624, 6,916,752, and 7,470,389 to Berrigan, all of which are incorporated by reference herein.

Fibers 115, after having passed through attenuator 16, may then be deposited onto a collector surface 19 where they are collected as a mass of fibers (mat) 20 as shown in FIG. 1. Collector surface 19 may comprise e.g. a single, continuous collector surface such as provided by a continuous belt or a drum or roll. Collector 19 may be generally porous and gas-withdrawal (vacuum) device 14 can be positioned below the collector to assist in the deposition of fibers onto the collector. The distance 21 between the attenuator exit and the collector, the amount of vacuum applied, and so on, may be varied to obtain different effects.

Regardless of the particular features (e.g., attenuator design, arrangement of the attenuator and collector, etc.) the above-described meltspinning process is distinguished from meltblowing. Specially, the passing of molten filaments through an air gap in which the filaments are at least partially solidified into fibers, followed by the attenuation/drawing of the fibers in a unit that is spaced away from the extrusion head (by the air gap), is distinguished from meltblowing processes in which air is impinged on molten filaments as close as possible to their point of exit from the orifices of the extrusion head.

Furthermore, the ordinary artisan will understand that meltspun fibers may be readily distinguished from meltblown fibers, by a variety of characteristics, e.g. the amount and nature of crystalline domains, molecular chain orientation, and so on.

The collected mat 20 of meltspun polylactic fibers may then be subjected to a bonding process in which at least some fibers of the mat are bonded to each other to transform the mat into a fiber web. Any suitable method may be used, whether such method relies on physical entanglement of fibers, melt-bonding of fibers to each other, bonding via some added agent, and so on. In some embodiments, the bonding may involve a thermal treatment (defined broadly herein as meaning exposure of the mat of meltspun, collected fibers to a temperature of at least about 80° C.), which may have particular advantages as discussed in detail herein.

In some embodiments the thermal bonding may take the form of autogenous bonding, defined herein as melt-bonding of the fiber-forming materials to each other at points of contact therebetween, such bonding being performed at an elevated temperature without the application of solid contact pressure onto the mat. (Such a bonding method may thus be contrasted with e.g. calendering. ultrasonic bonding, and the like.) Furthermore, such autogenous bonding does not involve the use of added binder (whether in fiber, powder, or liquid/latex form) or of any added adhesive or the like. Still further, autogenous bonding is distinguished from physical bonding methods such as needle-punching, hydroentanglement and the like. The ordinary artisan will appreciate that autogenous bonding (in particular, through-air bonding as described below), will provide fiber-fiber bonds that are readily distinguishable from bonds achieved by other means (e.g. by calendering or ultrasonic bonding, or by way of an added binder (whether in fiber, liquid, or powder form), or by needle-punching or hydroentangling).

In particular embodiments, the autogenous bonding may take the form of through-air bonding, as achieved by forcefully passing a stream of heated air through the mat of collected fibers (i.e., impinging the heated air onto the mat so that the heated air enters through a first major face of the mat, passes through the thickness of the mat, and exits through a second, opposing major face of the mat, assisted if desired by a vacuum applied to the second major face of the mat). Such bonding may be performed e.g. by the use of through-air bonder 101 as shown in exemplary embodiment in FIG. 1. Exemplary through-air bonders are discussed in detail in U.S. Patent Application Publication 2008/0038976 to Berrigan (which refers to these exemplary through-air bonders as quenched-flow heaters), which is incorporated by reference herein. It may be convenient that the heated, moving air be impinged onto a major surface of the fiber mat in a direction at least substantially normal to the major plane of the fiber mat (as illustrated by arrows 201 showing the direction of heated airflow in FIG. 1).

One of skill in the art will appreciate that thermal bonding (e.g., autogenous bonding, in particular through-air bonding) may be performed so as to melt-bond a sufficient number of fibers to each other to transform a meltspun fiber mat into a self-supporting fiber web (thus the web may be termed a spunbonded web), without heating the fibers to the point that they collapse or otherwise unacceptably reduce the porosity of the thus-formed web. However, it has also been found that when performed on polylactic acid fibers that comprise charging additive, such a thermal exposure may have additional and unexpected benefits in preserving the fiber charge over high-temperature aging, as discussed in detail elsewhere herein.

Autogenous bonding (e.g., through-air bonding) may utilize moving air that is heated (e.g. to a nominal set point, with the understanding that the air may cool slightly before encountering the fiber mat) to any suitable temperature that is sufficient to adequately bond the particular polylactic fibers used and that is sufficient to achieve the advantageous effects on the preservation of fiber charge that are disclosed herein. In various embodiments, the moving air may be provided at a temperature of at least about 90, 100, 120, 130, 140, 150, 160, or 170° C. In further embodiments, the moving air may be provided at a temperature of at most about 200, 180, 170, 160, 150, or 140° C.

Moving heated air may be impinged on the fiber mat at any linear velocity suitable to achieve the effects described herein. In various embodiments, the linear velocity of the heated air may be at least about 150, 200, 300, 500, 600, or 800 meters per minute. In further embodiments, the linear velocity of the heated air may be at most about 1500, 1200, 1000, 800, or 600 meters per minute. The ordinary artisan will understand that the temperature of the heated moving air and/or the velocity of the heated moving air, may be chosen in combination with the duration of the exposure of the fiber mat to the moving heated air, to achieve a desired cumulative overall thermal exposure. In various embodiments, the duration of exposure to the moving heated air (e.g., the residence time of the mat/web in proximity to the through-air bonder), may be at least about 0.1, 0.2, 0.4, 0.8, 1, 2, or 4 seconds. In further embodiments, the duration of exposure to the moving heated air may be at most about 4, 2, 1, 0.8, or 0.4 seconds.

Any charging method known in the art may be used. Exemplary methods include e.g. corona charging and hydrocharging. In some embodiments, a combination of corona charging and hydrocharging (in any order) may also be used (fibers charged in this manner will be referred to as corona-hydrocharged fibers, with no order of operation being implied). Corona charging may be performed e.g. by exposing the web to a suitable DC corona discharge to provide the web with filtration enhancing electret charge, using e.g. methods described in U.S. Reissue Pat. No. 30782 to van Turnhout and U.S. Pat. No. 4,215,682 to Davis. Hydrocharging may be performed e.g by impinging jets of water or a stream of water droplets onto the web at a pressure sufficient to provide the web with filtration enhancing electret charge. The pressure necessary to achieve optimum results may vary depending on the type of sprayer used, the particular composition of the fibers, the type and concentration of any charging additives if present, the thickness and density of the web; and, whether pre-treatment, such as DC corona surface treatment, was carried out prior to hydrocharging. An apparatus of the general type useful for hydraulically entangling fibers may be useful for hydrocharging, although a hydrocharging operation may often be carried out at lower pressures than those generally used in hydroentangling. Hydrocharging is understood to also include the methods described in U.S. Pat. No. 5,496,507 to Angadjivand and other various derivative methods for imparting an electret charge using a fluid wetting and dewetting process (as described in, for example, Japanese Patent Application Number JP 2002161467 to Horiguchi).

Other methods of charging (e.g., tribocharging and the like) may also be suitable. A charging operation (of any type) may be performed in-line with the web-production process; or, if desired, the formed web may be stored (e.g., wound into a roll) until such time as it is desired to charge the web.

However achieved, the charging process will produce an electret web as disclosed herein. An X-Ray Discharge Test may be used to identify and/or characterize electret webs. In such a test, the filtration performance of the web is measured before and after exposure of the web to ionizing radiation in the form of X-rays. If the filtration performance is essentially unchanged after exposure to X-rays, this is indicative that very few or no charges were neutralized by the exposure to X-rays and that the web did not have sufficient charges to be considered an electret web. However, if the filtration performance diminishes sufficiently after exposure to X-ray radiation, this result is indicative that the web was an electret web. (The ordinary artisan will appreciate that the ability of such strong measures as ionizing radiation to neutralize such charges does not conflict with the description of electret charges as being “quasi-permanent”). In an X-Ray Discharge test, a % Penetration Ratio (of an aerosol through the web) can be obtained before and after exposure of the web to the X-ray radiation, following the procedures and calculation methods disclosed in PCT International Patent Application Publication WO2014/105107, which is incorporated by reference herein in its entirety. In order for a web to be considered an electret web as defined herein, the % Penetration Ratio is at least about 300%. In various embodiments, the % Penetration Ratio is at least 400%, 500%, or 600%. In further embodiments, the % Penetration Ratio is at least 750% or 800%. In particular embodiments, the % Penetration Ratio is at least 1000%, or at least 1250%. In some embodiments, the % Penetration Ratio is at most about 4000%.

The electrospun web with high optical transmittance may be formed into, or be incorporated or integrated with, other supporting layers or pre-filter layers of materials for purposes of filtration and the like. In one embodiment, the integrated media remains transparent or translucent. Examples of other supportive layers include, but are not limited to: nonwovens, mesh frames, clothes, via thermal bonding, ultrasonic bonding, gluing, etc. For such purposes, the electrospun web may be conveyed to any desired apparatus such as one or more embossing stations, laminators, cutters and the like. If desired, one or more secondary bonding operations (in addition to the autogenous bonding) may be performed. Any such operation may be done in-line with the web-producing operation; or the web may be wound into a storage roll until such time as it is desired to be further processed. Thus, in some embodiments the spunbonded webs may be provided as one or more of sublayers in a multilayer article.

In some embodiments, the electrospun web of the present invention may be used for filtration, e.g. air filtration. Electrospun webs as described herein can exhibit advantageous filtration properties, for example high filtration efficiency in combination with low pressure drop. Such properties may be characterized by any of the well-known parameters including percent penetration, pressure drop, capture efficiency (e.g., Minimum Composite Efficiency, Minimum Efficiency Reporting Value), and the like. In particular embodiments, webs as disclosed herein comprise a Quality Factor of at least about 0.3, 0.4, 0.5, 0.6, 0.7, 0.8, or 1.0.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

### Example 1

Spinnable solutions were prepared according to Table 1.

TABLE 1
Polymer solutions used in electrospinning studies.

| Polymer | Polymer | Supplier | | Polymer | Supplier |
|---|---|---|---|---|---|
| (wt % in solution) | reference | Designation | Solvent | Supplier | Location |
| Polyvinyl alcohol | PVA | PVA235 | Water containing | Kuraray | New York, |
| (6 wt %) | | | 0.5% sodium | | NY |
| | | | dodecylsulfate | | |
| Polycaprolactam | PCA | B3EG6 | Formic acid | BASF | Florham Park, |
| (12 wt %) | | | | Corporation | NJ |
| Polyvinylidene fluoride | PVDF | 6020/1001 | Dimethyl formamide | Solvay USA Inc. | Princeton, NJ |
| (10 wt %) | | | | | |
| Thermoplastic | TPU | T-8190N 90A | Dimethyl formamide | Covestro | Pittsburgh, PA |
| polyurethane (10 wt %) | | | | | |
| Tetrafluoroethylene, | THV | THV220A | Amyl Acetate and | 3M | St. Paul, MN |
| hexafluoropropylene, and | | | DMF (1:1) | | |
| vinylidene fluoride | | | | | |
| copolymer (12 wt %). | | | | | |
| Polylactic acid | PLA | 6100D | Dichloromethane | NatureWorks | Minnetonka, |
| (20 wt %) | | | | | MN |

All samples were prepared using a NanoSpider NS 1S500U (Elmarco s.r.o., Liberec, Czech Republic) electrospinning machine. Settings for electrospinning were 82 kilovolts (kV), 17 cm, 35° C., 30 percent relative humidity (% R.H.), and the nanofibers were carried on 23 grams per square meter (gsm) polypropylene spunbond substrate, whose filtration performance had a pressure drop of 0.36 millimeters water (mm H₂O) and penetration of 99.67% (referred to as Pen %).

The basis weight of the electrospun nanofiber layer was adjusted by controlling the wind speed of the NanoSpider machine. The production rate of nanofibers of the machine was constant, so the basis weight of the as-spun nanofibers is in negative power relationship with the winding speed. In this experiment, the nanofibers produced are referred to by their polymer type and winding speed. For example, PVA 100 means PVA nanofibers collected with a winding speed of 100 mm/min. The XXX100 samples could be peeled off the substrate and weighed, allowing direct determination of their basis weights. The basis weights of the samples collected at other winding speeds were calculated as proportional to the basis weight of the corresponding weighed XXX100 sample. For example, the basis weight of a sample collected with a winding speed of 300 mm/min was calculated to be one third that of the XXX100 sample by simple division, and so forth. Then the filtration performances of e-spun samples of different basis weight were characterized, summarized in Table 2. Filter performance was measured using ASTM F3502 on a TSI 8130 air filtration tester (TSI Inc., Shoreview, MN), with an air flow rate of 85 liters per minute, 0.3 μm NaCl challenges with concentration of about 28 mg/m³.

TABLE 2
Filtration Data of Electrospun Nanofiber
Media of Different Basis Weights.

| | PD mmH₂O | Pen % | Basis | Fiber |
|---|---|---|---|---|
| | (Avg.) | (Avg.) | Weight | Diameter |
| PVA600 | 15.130 | 13.16 | 0.313 | 500 nm |
| PVA500 | 22.333 | 5.62 | 0.376 | |
| PVA400 | 26.497 | 3.02 | 0.470 | |
| PVA300 | 37.201 | 0.85 | 0.627 | |
| PVA200 | 62.260 | 0.10 | 0.940 | |
| PVA100 | 141.033 | 0.0076 | 1.880 | |
| PCA600 | 9.433 | 16.57 | 0.0548 | 260 nm |
| PCA500 | 12.566 | 10.03 | 0.0658 | |
| PCA400 | 16.533 | 4.64 | 0.0822 | |
| PCA300 | 20.763 | 4.20 | 0.109 | |
| PCA200 | 29.933 | 0.326 | 0.164 | |
| PCA100 | 44.963 | 0.029 | 0.329 | |
| PVDF600 | 3.963 | 46.82 | 0.617 | |
| PVDF500 | 4.993 | 40.15 | 0.740 | |
| PVDF400 | 8.103 | 26.27 | 0.925 | |
| PVDF300 | 11.433 | 17.93 | 1.233 | |
| PVDF200 | 29.803 | 4.61 | 1.850 | |
| PVDF100 | 251.633 | 12.8 | 3.70 | |
| TPU600 | 0.733 | 84.18 | 0.543 | 450 nm |
| TPU500 | 0.933 | 83.42 | 0.652 | |
| TPU400 | 1.033 | 82.25 | 0.815 | |
| TPU300 | 1.563 | 75.00 | 1.087 | |
| TPU200 | 1.763 | 74.13 | 1.630 | |
| TPU100 | 2.863 | 65.71 | 3.260 | |
| THV600 | 4.233 | 39.07 | 0.297 | 300 nm |
| THV500 | 5.363 | 31.5 | 0.356 | |
| THV400 | 6.693 | 23.64 | 0.445 | |
| THV300 | 9.563 | 13.13 | 0.593 | |
| THV200 | 14.133 | 5.80 | 0.890 | |
| THV100 | 26.563 | 0.864 | 1.780 | |
| PLA400 | 11.7 | 33.71 | 0.5925 | |
| PLA300 | 25.2 | 25.57 | 0.79 | |
| PLA200 | 32.8 | 11.39 | 1.185 | |
| PLA100 | 104 | 0.29 | 2.37 | |

In Table 2, it can be seen that the penetration and pressure drop of each set of samples have a good negative power relationship. For an air filtration material, the pressure drop and penetration should be as low as possible.

### Example 2

THV nanofibers of different basis weights were spun onto different nonwoven substrates and their penetration and pressure drop values were measured using a TSI 8130 air filtration tester with a flow rate of 85 liters per minute, and NaCl challenges with ˜28 mg/m³ concentration as provided in Table 3. The nonwoven substrates were spun-bond polypropylene having 23 gsm (23 gsm PPSB Control) and spun-bond polylactic acid having 15 gsm (15 gsm PLASB Control). In Table 3, the notation THV400+PPSB means THV nanofibers spun onto PP spunbond nonwoven substrate with winding speed of 400 mm/min, and THV500+PLA SB means THV nanofibers spun onto polylactic acid spunbond nonwoven substrate with winding speed of 500 mm/min, with the remainder labelled in an analogous fashion. The PLA SB nonwoven was prepared with a basis weight of 15 gsm. Due to its low basis weight and large pore size, the PLA SB nonwoven was optically transparent.

TABLE 3
Filtration Performances of nanofiber-laminated media

| Sample | Penetration % | PD (mmH₂O) |
|---|---|---|
| 23 gsm PPSB Control | 99.54 | 0.3 |
| Charged 23 gsm PPSB | 99.18 | 0.3 |
| 15 gsm PLASB Control | 97.9 | 0 |
| Charged 15 gsm PLASB | 87.5 | 0.6 |
| THV400 + PPSB | 17.7 | 7 |
| THV400 + PPSB | 16.6 | 7.4 |
| THV400 + PPSB | 19.1 | 6 |
| THV500 + PPSB | 25.2 | 5 |
| THV500 + PPSB | 25.6 | 5 |
| THV500 + PPSB | 27.5 | 5.4 |
| THV600 + PPSB | 30.3 | 4 |
| THV600 + PPSB | 34.5 | 4.6 |
| THV600 + PPSB | 36.4 | 4.2 |
| THV500 + PLASB | 18.2 | 4.1-6.4 |
| THV500 + PLASB | 19.7 | 4.1-6.0 |
| THV500 + PLASB | 15.4 | 5.2-7.2 |
| THV600 + PLASB | 25.4 | 3.1-5.4 |
| THV600 + PLASB | 24.6 | 3.2-5.8 |
| THV600 + PLASB | 23.7 | 3.2-5.7 |

Comparing the THV500+PPSB samples and the THV500+PLASB samples, which have the same amount of THV nanofibers coated, the two types of samples had different penetrations, with the THV500+PLASB samples having lower penetration than THV500+PPSB samples by 5.5%-12.1%. This is because the PLA SB media can hold charges during the electrospinning process. The electrospinning process is similar to corona charging process, but with smaller current, which makes the THV/PLA media behave like an electret nonwoven. To verify this, the spunbonded polylactic acid substrate was placed in the electrospinning machine and exposed to the high voltages of the electrospinning process, but no nanofibers were collected. This sample (Charged PLA SB) was tested using the TSI 8130 air filtration tester. In comparison to the unprocessed 23 gsm PLASB Control, the charged sample had about a ten percentage point lower penetration decrease. This corresponds well with the differences between the THV500+PLASB samples and the THV500+PPSB samples. The 23 gsm PPSB substrate was also charged and tested in this fashion and did not show a significant filtration performance change. This demonstrates that the use of chargeable webs provides lower penetration.

### Example 3. Comparative Study of Filtration Performances of Masks

A prototype respirator was made using THV500+PLASB and the filtration performance of the respirator was tested using a TSI 8130 air filtration tester with flow rate of 85 liters per minute, and NaCl challenges with ˜28 mg/m3 concentration. The performance of several commercially available masks was also evaluated. The performance data is provided in Table 4.

TABLE 4
Comparative Study of Filtration Performances of Masks.

| Item | Penetration (%) | Pressure Drop (mmH₂O) | Source (location) |
|---|---|---|---|
| THV500 + PLASB | 10.4 ± 0.9 | 4.6 ± 1.1 | |
| Surgical Mask 1 | 10.2 ± 0.2 | 12.5 ± 0.4 | Contier Medical (China) |
| Surgical Mask 2 | 16.8 | 4.9 | BYD Face Mask (obtained from |
| | | | Costco) |
| Cloth Mask 1 | 59.1 ± 2.4 | 7.7 ± 0.1 | 3M Company (St. Paul, MN) |
| (3M Nexcare | | | |
| Comfort 8550) | | | |
| Cloth Mask 2 | 76.4 ± 6.1 | 6.6 ± 1.7 | Cotton mask |

Transparent Mask 1 was made from THV500+PLA SB. The mask's performance was 5%-9% lower in penetration and 1-2 mmH₂O lower in pressure drop than the starting material, THV500+PLASB media. This is because the actual area of the mask is greater than flat media, which allows a greater area to filtrate the particles and allow a larger amount of air to permeate. Mask and respirator prototypes usually present higher filtration performance than flat media.

Surgical Mask 1 is a commercially available product bought available under the brand name of Contier Medical. TSI 8130 air filtration tester results show its penetration is around 10%, but with a higher breath resistivity of 12.5 mmH₂O.

Surgical Mask 2 is a commercially available product. TSI 8130 air filtration tester tests show its penetration is around 16.8%, and with breath resistivity of 4.9 mmH₂O.

Cloth Mask 1 is commercially available product made by 3M, under the brand name of NEXCARE COMFORT 8550. This mask shows penetration of around 59.1%, and with breath resistivity of 7.7 mmH₂O.

Cloth Mask 1 is commercially available product and is described as a 100% pure cotton mask. This mask shows penetration of around 76.4%, and with breath resistivity of 6.6 mmH₂O.

The data show that masks made according to this disclosure have the ability to provide a protection level similar to that of a surgical mask. Additionally, these masks are translucent and allow the facial expressions of the wearer to be visible.

### Example 4

Electrospun nanofibers were made using Nanospinner 24 multi-needle electrospinning equipment (Inovenso Inc., Woburn, MA). Polyvinylidene fluoride (PVDF) and polylactic acid (PLA) nanofibers were made at 15 kV to 20 kV (25° C. and 20% humidity) with a 10-needle spinneret. A TSI 8130 air filtration tester with NaCl aerosol was used to test the filtration performance of the samples with air flow rate at 85 liters per minute. Performance data for the nanofiber samples made in this study are provided in Table 5.

TABLE 5
Electrospun nanofibers made with Nanospinner 24.

| | | Basis | |
|---|---|---|---|
| | Average fiber | Weight | Solution (wt % polymer in solvent (Source, |
| Sample | diameter (nm) | (gsm) | Location)) |
| PVDF545 | 545 nm | 0.354 | 10 wt % PVDF in dimethyl formamide (Arkema, |
| | | | King of Prussia, PA) |
| PVDF189 | 189 nm | 0.231 | 8 wt % PVDF in dimethyl formamide (Arkema, |
| | | | King of Prussia, PA) |
| PLA655 | 655 nm | 0.315 | 10 wt % Natureworks 6100 PLA in |
| | | | dichloromethane: dimethyl formamide (2:1) |
| | | | (NatureWorks, Minnetonka, MN) |
| PLA215 | 215 nm | 0.291 | 10 wt % Natureworks 6100 PLA in |
| | | | dichloromethane: dimethyl formamide (1:1) |
| | | | (NatureWorks, Minnetonka, MN) |

Table 6 shows the air filtration efficiency, pressure drop, and optical clarity of various air filtration media with and without PLA or PVDF electrospun nanofiber on different substrates. Data for a commercial surgical mask is also provided. The basis weight of the electrospinning web was controlled to be 0.1 to 0.5 gsm by the collector speed and collection time. The electrospun nanofibers improved the air filtration performance of both substrates compared to the substrate alone. It was possible to achieve similar air filtration performance compared to that of the commercial surgical mask. The optical clarity of the substrates is much higher compared to a commercialized surgical mask. It was possible to clearly see facial expressions through all the substrates and nanofiber layers. For electrospun materials, clarity was higher with smaller fiber size because the nanofiber size was approaching the wavelength of visible light. The filtration efficiency was also higher with decreasing fiber size due to increased surface area of the nanofibers.

TABLE 6
Air filtration performance and optical clarity of various filtration media

| | Flow (liters | Pressure drop | | |
|---|---|---|---|---|
| Sample | per min) | (mmH₂O) | Pen % | Clarity |
| Commercial Surgical Mask | 84.9 | 4.9 | 16.8 | 5% |
| PLA spunbond 15 gsm | 85 | 0.4 | 93 | 85% |
| TRANSPORE Tape (3M Company) | 85.1 | 70.8 | 89.9 | 82% |
| PLA655 + perforated TRANSPORE tape | 85 | 10 | 14.0 | 89% |
| PLA215 + perforated TRANSPORE tape | 85.2 | 12 | 13.5 | 88% |
| PLA655 + PLA spunbond 15 gsm | 84.7 | 3.8 | 56.8 | 78% |
| PLA215 + PLA spunbond 15 gsm | 85.0 | 4.7 | 26.1 | 82% |
| PVDF545 + PLA spunbond 15 gsm | 85.1 | 4.2 | 30.7 | 75% |
| PVDF189 + PLA spunbond 15 gsm | 85.2 | 5.1 | 20.3 | 81% |

Table 7 shows air filtration performance of charged and uncharged media. The charged nanofiber media with spunbond substrate showed enhanced filtration efficiency. The pressure drop and filtration efficiency after charging were comparable to that of a commercial surgical mask. After charging, the clarity of the webs was also maintained.

TABLE 7
Air filtration performance of charged and uncharged media.

| Sample | Charged | Pressure drop (mmH₂O) | Pen % |
|---|---|---|---|
| Commercial Surgical Mask | Yes | 4.9 | 16.8 |
| PLA655 + PLA spunbond 15 gsm | No | 3.8 | 26.1 |
| PLA215 + PLA spunbond 15 gsm | No | 4.7 | 30.7 |
| PVDF545 + PLA spunbond 15 gsm | No | 4.2 | 20.3 |
| PVDF189 + PLA spunbond 15 gsm | No | 5.1 | 56.8 |
| PLA655 + PLA spunbond 15 gsm | Yes | 3.8 | 20.1 |
| PLA215 + PLA spunbond 15 gsm | Yes | 4.7 | 15.1 |
| PVDF545 + PLA spunbond 15 gsm | Yes | 4.2 | 21.7 |
| PVDF189 + PLA spunbond 15 gsm | Yes | 5.1 | 11.3 |

Although the present invention has been described with reference to preferred embodiments, workers skilled in the art will recognize that changes may be made in form and detail without departing from the spirit and scope of the invention.

What is claimed is:

1. An electrospun web comprising:
a carrier substrate; and
an electrostatically charged nanofiber,
wherein the electrospun web has a pressure drop of about 5 mmH2O or less, a percent penetration of about 50% or less, and a clarity of about 80% or more.

2. The electrospun web of claim 1, having a percent penetration of about 40% or less.

3. The electrospun web of claim 1, having a percent penetration of about 30% or less.

4. The electrospun web of claim 1, wherein the electrostatically charged nanofiber has a basis weight of about 0.7 gsm or less.

5. The electrospun web of claim 1, wherein the electrostatically charged nanofiber a basis weight of about 0.5 gsm or less.

6. The electrospun web of claim 1, wherein the carrier substrate is one of a nonwoven, a mesh, or a perforated film.

7. The electrospun web of claim 1, wherein the carrier substrate is a spunbond nonwoven substrate.

8. The electrospun web of claim 7, wherein the spunbond nonwoven substrate has a basis weight of about 30 gsm or less.

9. The electrospun web of claim 1, wherein the carrier substrate has a porosity of about 50% or greater.

10. The electrospun web of claim 1, wherein the electrospun web is used as a filtration media.

11. A filtration media comprising:
a carrier layer; and
an electrospun nanofiber layer,
wherein the filtration media has a pressure drop of about 5 mmH2O or less, a percent penetration of about 50% or less, and a clarity of about 80% or more.

12. The filtration media of claim 11, having a percent penetration of about 40% or less.

13. The filtration media of claim 11, having a percent penetration of about 30% or less.

14. The filtration media of claim 11, wherein the electrospun nanofiber layer has a basis weight of about 0.7 gsm or less.

15. The filtration media of claim 11, wherein the carrier layer is one of a nonwoven, a mesh, or a perforated film.

16. The filtration media of claim 11, wherein the carrier layer is a spunbond nonwoven substrate having a basis weight of about 30 gsm or less.

17. A mask comprising:
an electrostatically charged spunbond nonwoven,
wherein the mask has a pressure drop of about 5 mmH2O or less, a filtration efficiency of about 40% or greater, and a clarity of about 80% or more.

18. The mask of claim 17, having a percent penetration of about 50% or less.

19. The mask of claim 17, wherein the mask comprises nanofibers.

20. The mask of claim 19, wherein the nanofibers are made from fluorinated polymers.
